(19) United States
(12) Patent Application Publication
(10) Pub. No.: US 2024/0367152 A1
(43) Pub. Date: Nov. 7, 2024

(54) Process and System for Lithium Extraction

(71) Applicant: Geo40 Limited, Taupo (NZ)

(72) Inventors: Campbell McNicoll, Taupo (NZ); Michael T. O'Sullivan, Taupo (NZ); William L. Bourcier, Taupo (NZ)

(21) Appl. No.: 18/567,715

(22) PCT Filed: Jun. 10, 2022
(86) PCT No.: PCT/NZ2022/050075

§ 371 Date: Dec. 6, 2023

(30) Foreign Application Priority Data
Jun. 11, 2021 (AU) AU2021901768A
Jun. 10, 2022 (WO) PCT/NZ2022/050075

(51) Int. Cl. B01J 20/34; B01D 15/20; B01J 20/06; C22B 3/02; C22B 3/24; C22B 26/12

(52) U.S. Cl. CPC B01J 20/3433; B01D 15/203; B01J 20/06; B01J 20/3475; B01J 20/3483; C22B 3/02; C22B 3/24; C22B 26/12

(57) ABSTRACT

The present disclosure provides a process for recycling sorbent used in a process for extracting lithium from an aqueous solution containing lithium. The process may comprise bringing an aqueous solution containing lithium into contact with a hydrogen manganese oxide sorbent to absorb the lithium to produce a lithium loaded sorbent and lithium depleted solution, separating the lithium loaded sorbent and the lithium depleted solution, bringing the lithium loaded sorbent into contact with an acid to produce a lithium rich liquor and regenerated sorbent, separating the lithium rich liquor and the regenerated sorbent, treating the separated lithium rich liquor with a carbonate and/or hydroxide to precipitate manganese carbonate and/or manganese hydroxide, separating precipitated manganese carbonate and/or manganese hydroxide from the lithium rich liquor, and heating the manganese carbonate and/or manganese hydroxide with a source of lithium to produce a regenerated lithium loaded sorbent which is reused in the process. The disclosure also provides a system for recycling sorbent used in a process for extracting lithium from an aqueous solution containing lithium.

### TECHNICAL FIELD

This disclosure relates to a process for recycling sorbent used in a process for extracting lithium from an aqueous solution containing lithium and/or a system for recycling sorbent used in a process for extracting lithium from an aqueous solution containing lithium.

### BACKGROUND ART

Lithium is present naturally in many rocks (such as pegmatites), ocean water, brines, mineral springs and ground waters. Lithium solutions can also be a side product from lithium processing facilities, battery recycling plants, oil well brines or other waste or process streams. However, these sources may only contain low concentrations of lithium, for example sea water contains less than 1 ppm of lithium. Therefore, to be extracted for use, the lithium must be concentrated and/or converted into a useful chemical form.

Lithium has many uses, but one of the most dominant is the manufacture of batteries, which has high demand due to the growing use of electronics, electric vehicles and storage of renewable energy such as solar power.

Lithium can be extracted from solution (for example brines) using a sorbent. For example, JPS61247618A describes a method for recovering lithium from geothermal hot water using a manganese dioxide sorbent. JPS61247618A notes the manganese dioxide may be recycled. However, it has been found the sorbent may break down over time/cycles and therefore may need to be replenished after successive cycles. This may make the process less commercially viable, due to the costs of replacing/replenishing the sorbent.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of this disclosure to provide a process for recycling sorbent used in a process for extracting lithium from an aqueous solution containing lithium and/or a system for recycling sorbent used in a process for extracting lithium from an aqueous solution containing lithium which goes at least some way towards overcoming one or more of the abovementioned problems or difficulties, or to at least provide the industry/public with a useful choice.

### SUMMARY

In a first aspect there is provided a process for recycling sorbent used in a process for extracting lithium from an aqueous solution containing lithium, the process comprising,
(i) bringing an aqueous solution containing lithium into contact with a hydrogen manganese oxide sorbent to absorb the lithium to produce a lithium loaded sorbent and lithium depleted solution,
(ii) separating the lithium loaded sorbent and the lithium depleted solution,
(iii) bringing the lithium loaded sorbent into contact with an acid to produce a lithium rich liquor and regenerated sorbent,
(iv) separating the lithium rich liquor and the regenerated sorbent,
(v) treating the separated lithium rich liquor with a carbonate and/or hydroxide to precipitate manganese carbonate and/or manganese hydroxide,
(vi) separating precipitated manganese carbonate and/or manganese hydroxide from the lithium rich liquor, and
(vii) heating the manganese carbonate and/or manganese hydroxide with a source of lithium to produce a regenerated lithium loaded sorbent which is reused in the process.

In a second aspect the invention provides a system for recycling sorbent used in a process for extracting lithium from an aqueous solution containing lithium, the system comprising,
a container for bringing an aqueous solution containing lithium into contact with a hydrogen manganese oxide sorbent to absorb the lithium to produce a lithium loaded sorbent and lithium depleted solution,
separation means to separate the lithium loaded sorbent and the lithium depleted solution,
a source of acid to treat the lithium loaded sorbent to produce a lithium rich liquor and regenerated sorbent,
separation means to separate the lithium rich liquor and the regenerated sorbent,
carbonate and/or hydroxide dosing means to treat the lithium rich liquor with a carbonate and/or hydroxide to precipitate manganese carbonate and/or manganese hydroxide,
precipitate separation means to separate precipitated manganese carbonate and/or manganese hydroxide from the lithium rich liquor, and
a heat source and a lithium source to heat the manganese carbonate or manganese hydroxide with the lithium source to produce the lithium loaded sorbent.

In some embodiments, the lithium rich liquor is treated with a carbonate, precipitated manganese carbonate is separated from the lithium rich liquor and manganese carbonate is heated with the source of lithium.

In some embodiments, the source of lithium comprises one or more of lithium hydroxide, lithium carbonate or lithium oxide.

In some embodiments, the source of lithium is heated with the manganese carbonate and/or manganese hydroxide at a mole ratio of about 1:1 to 1:3 lithium to manganese.

In some embodiments the source of lithium is heated with the manganese carbonate and/or manganese hydroxide at a mole ratio of about 0.75 lithium to manganese (for example, a mole ratio of 0.75 Li to 1 Mn).

In some embodiments, the source of lithium is heated with the manganese carbonate at a mole ratio of about 1:1 to 1:3 lithium to manganese.

In some embodiments the source of lithium is heated with the manganese carbonate at a mole ratio of about 0.75 lithium to manganese (for example, a mole ratio of 0.75 Li to 1 Mn).

In some embodiments, the manganese carbonate and/or manganese hydroxide is calcined with the source of lithium.

In some embodiments, the manganese carbonate is calcined with the source of lithium.

In some embodiments, the manganese carbonate and/or manganese hydroxide is heated at about 300 to 1000° C. with the source of lithium. In some embodiments, the manganese carbonate and/or manganese hydroxide is heated at about 300 to 900° C. with the source of lithium. In some embodiments, the manganese carbonate and/or manganese hydroxide is heated at about 350 to 1000° C. with the source of lithium. In some embodiments, the manganese carbonate and/or manganese hydroxide is heated at about 350 to 900° C. with the source of lithium. In some embodiments, the manganese carbonate and/or manganese hydroxide is heated at about 400 to 1000° C. with the source of lithium. In some embodiments, the manganese carbonate and/or manganese hydroxide is heated at about 400 to 900° C. with the source of lithium.

In some embodiments, the manganese carbonate and/or manganese hydroxide is heated at about 300 to 800° C. with the source of lithium.

In some embodiments, the manganese carbonate and/or manganese hydroxide is heated at about 300 to 800° C. for about 4 to 12 hours with the source of lithium.

In some embodiments, the manganese carbonate and/or manganese hydroxide is heated at about 400 to 800° C. with the source of lithium.

In some embodiments, the manganese carbonate and/or manganese hydroxide is heated for about 1 to 72 hours, about 1 to 48 hours, about 1 to 24 hours, about 4 to 12 hours, or about 4 to 8 hours with the source of lithium. In some embodiments, the manganese carbonate and/or manganese hydroxide is heated for about 4 to 12 hours with the source of lithium. In some embodiments, the manganese carbonate and/or manganese hydroxide is heated for about 5 hours with the source of lithium.

In some embodiments, the manganese carbonate and/or manganese hydroxide is heated at about 400 to 800° C. for about 1 to 72 hours with the source of lithium. In some embodiments, the manganese carbonate and/or manganese hydroxide is heated at about 400 to 800° C. for about 1 to 24 hours with the source of lithium. In some embodiments, the manganese carbonate and/or manganese hydroxide is heated at about 400 to 800° C. for about 4 to 12 hours with the source of lithium. In some embodiments, the manganese carbonate and/or manganese hydroxide is heated at about 400 to 800° C. for about 4 to 8 hours with the source of lithium. In some embodiments, the manganese carbonate and/or manganese hydroxide is heated at about 400 to 800° C. for about 5 hours with the source of lithium.

In some embodiments, the manganese carbonate and/or manganese hydroxide is heated at about 400 to 700° C. with the source of lithium.

In some embodiments, the manganese carbonate and/or manganese hydroxide is heated at about 400 to 700° C. for about 4 to 12 hours with the source of lithium.

In some embodiments, the manganese carbonate and/or manganese hydroxide is heated at about 450 to 700° C. with the source of lithium.

In some embodiments, the manganese carbonate and/or manganese hydroxide is heated at about 450 to 700° C. for about 4 to 12 hours with the source of lithium.

In some embodiments, the manganese carbonate and/or manganese hydroxide is heated at about 450 to 700° C. for about 4 to 8 hours with the source of lithium.

In some embodiments, the manganese carbonate and/or manganese hydroxide is heated at about 450 to 700° C. for about 5 hours with the source of lithium.

In some embodiments, the manganese carbonate is heated at about 550 to 800° C. with the source of lithium.

In some embodiments, the manganese carbonate is heated at about 550 to 800° C. for about 4 to 12 hours with the source of lithium.

In some embodiments, the manganese carbonate is heated at about 600 to 700° C. with the source of lithium.

In some embodiments, the manganese carbonate is heated at about 600 to 700° C. for about 4 to 12 hours with the source of lithium.

In some embodiments, the manganese carbonate is heated at about 600 to 700° C. for about 4 to 8 hours with the source of lithium.

In some embodiments, the manganese carbonate is heated at about 600 to 700° C. for about 5 hours with the source of lithium.

In some embodiments, the source of lithium comprises one or more of lithium hydroxide, lithium carbonate or lithium oxide.

In some embodiments, the carbonate is any one or more of sodium carbonate, ammonium carbonate, and potassium carbonate. In some embodiments, the carbonate is sodium carbonate.

In some embodiments, the hydroxide is any one or more of sodium hydroxide, potassium hydroxide, and ammonium hydroxide.

In some embodiments, the separated lithium rich liquor is treated with the carbonate and/or hydroxide until a basic or neutral pH is achieved.

In some embodiments, the separated lithium rich liquor is treated with the carbonate and/or hydroxide until pH about 6 to 8 is achieved.

In some embodiments, a base is added to the separated lithium rich liquor in addition to the carbonate and/or hydroxide.

In some embodiments, the base is added to the separated lithium rich liquor to adjust the pH to about 3-4.

In some embodiments, the manganese carbonate or manganese hydroxide is separated from the lithium rich liquor by filtration.

In some embodiments, the hydrogen manganese oxide sorbent and/or the lithium loaded sorbent is in powder form, pellet form or bead form.

In some embodiments, the hydrogen manganese oxide sorbent and/or the lithium loaded sorbent is in powder form. In some embodiments, the hydrogen manganese oxide sorbent and/or the lithium loaded sorbent is in compacted powder form. In some embodiments, the hydrogen manganese oxide sorbent and/or the lithium loaded sorbent is in loose powder form.

In some embodiments, the manganese carbonate and/or manganese hydroxide and the source of lithium are milled together.

In some embodiments, the manganese carbonate and the source of lithium are milled together.

In some embodiments, the lithium loaded sorbent is ball milled, ring milled, and/or bead milled after heating.

In some embodiments, the lithium loaded sorbent is milled to a powder having a particle size of about less than 100 microns after heating.

In some embodiments, the amount of the hydrogen manganese oxide sorbent contacted with the aqueous solution containing lithium is in an equivalent capacity relative to lithium in the aqueous solution. In some embodiments, the amount of the hydrogen manganese oxide sorbent contacted with the aqueous solution containing lithium is in excess capacity to the amount of lithium in the aqueous solution. In some embodiments, the amount of the hydrogen manganese oxide sorbent is in about 1 to 10, about 1 to 5 or about 1 to 3 capacity to the amount of lithium in the aqueous solution. In some embodiments, the amount of the hydrogen manganese oxide sorbent is in about 1 to 3 capacity to the amount of lithium in the aqueous solution.

In some embodiments, the hydrogen manganese oxide sorbent in step (i) is in an equivalent capacity relative to lithium in the aqueous solution. In some embodiments, the hydrogen manganese oxide sorbent in step (i) is in excess capacity to the amount of lithium in the aqueous solution. In some embodiments, the hydrogen manganese oxide sorbent in step (i) is in about 1 to 10, about 1 to 5 or about 1 to 3 capacity to the amount of lithium in the aqueous solution. In some embodiments, the hydrogen manganese oxide sorbent in step (i) is in about 1 to 3 capacity to the amount of lithium in the aqueous solution.

In some embodiments, the aqueous solution containing lithium is agitated and/or stirred when contacted with the hydrogen manganese oxide sorbent.

In some embodiments, the aqueous solution is in contact with the hydrogen manganese oxide sorbent for about 20 seconds to 12 hours. In some embodiments the aqueous solution is in contact with the hydrogen manganese oxide sorbent for about 30 seconds to 12 hours. In some embodiments, the aqueous solution is in contact with the hydrogen manganese oxide sorbent for about 1 minute to 12 hours. In some embodiments, the aqueous solution is in contact with the hydrogen manganese oxide sorbent for about 1 minute to 10 hours. In some embodiments, the aqueous solution is in contact with the hydrogen manganese oxide sorbent for about 1 minute to 8 hours. In some embodiments, the aqueous solution is in contact with the hydrogen manganese oxide sorbent for about 1 minute to 6 hours. In some embodiments, the aqueous solution is in contact with the hydrogen manganese oxide sorbent for about 1 minute to 5 hours. In some embodiments, the aqueous solution is in contact with the hydrogen manganese oxide sorbent for about 1 minute to 4 hours. In some embodiments, the aqueous solution is in contact with the hydrogen manganese oxide sorbent for about 2 minutes to 4 hours. In some embodiments, the aqueous solution is in contact with the hydrogen manganese oxide sorbent for about 5 minutes to 3 hours.

In some embodiments, the hydrogen manganese oxide sorbent is brought into contact with the aqueous solution containing lithium at about 1 to 500 g/L (g of sorbent per L of aqueous solution containing lithium). In some embodiments, the hydrogen manganese oxide sorbent is brought into contact with the aqueous solution containing lithium at about 1 to 200 g/L. In some embodiments, the hydrogen manganese oxide sorbent is brought into contact with the aqueous solution containing lithium at about 1 to 100 g/L. In some embodiments, the hydrogen manganese oxide sorbent is brought into contact with the aqueous solution containing lithium at about 5 to 50 g/L.

In some embodiments, water is added to the separated lithium loaded sorbent.

In some embodiments, water is added to the separated lithium loaded sorbent at about 1 to 1000 g/L. In some embodiments water is added to the separated lithium loaded sorbent at about 200 to 900 g/L. In some embodiments, water is added to the separated lithium loaded sorbent at about 400 to 900 g/L. In some embodiments, water is added to the separated lithium loaded sorbent at about 600 to 900 g/L. In some embodiments, water is added to the separated lithium loaded sorbent at about 700 g/L.

In some embodiments, the acid in step (iii) or the source of acid is selected from one or more mineral acids and/or organic acids.

In some embodiments, the acid in step (iii) or the source of acid substantially does not dissolve the sorbent.

In some embodiments, the acid in step (iii) or the source of acid is selected from one or more of HCl, H₂SO₄, HBr, HI and phosphoric acid.

In some embodiments, the acid in step (iii) or the source of acid is added until pH of about 1 to 2 is achieved.

In some embodiments, the acid in step (iii) or the source of acid is added at about 2:1 to 1:1 ratio of acid to the lithium held by the sorbent (for example the acid is in excess to stoichiometric ratio to the lithium).

In some embodiments, the acid in step (iii) or the source of acid is added at about 1:1 stoichiometric ratio of acid to the lithium held by the sorbent.

In some embodiments, the acid in step (iii) or the source of acid is added in a single batch or gradually. In some embodiments the acid is added gradually.

In some embodiments, the acid in step (iii) or the source of acid is a dilute acid.

In some embodiments, the lithium loaded sorbent and the lithium depleted solution are separated by any one or more of settling, decanting and/or filtration. In some embodiments, the lithium loaded sorbent and the lithium depleted solution are separated by filtration.

In some embodiments, the process further comprises the step of washing the lithium loaded sorbent.

In some embodiments, the process further comprises the step of washing the lithium loaded sorbent with water.

In some embodiments, the lithium rich liquor and regenerated sorbent are separated by any one or more of settling, decanting and/or filtration. In some embodiments the lithium rich liquor and regenerated sorbent are separated by filtration.

In some embodiments, the process further comprises concentrating the lithium rich liquor.

In some embodiments, the concentrating of the lithium rich liquor is prior to separating the lithium rich liquor and the regenerated sorbent.

In some embodiments, the concentrating of the lithium rich liquor is after separating the lithium rich liquor and the regenerated sorbent.

In some embodiments, the concentrating of the lithium rich liquor is after separating precipitated manganese carbonate and/or manganese hydroxide from the lithium rich liquor.

In some embodiments, the concentrating of the lithium rich liquor is prior to separating precipitated manganese carbonate and/or manganese hydroxide from the lithium rich liquor.

In some embodiments, the lithium rich liquor is concentrated by reverse osmosis.

In some embodiments, the lithium rich liquor is concentrated by evaporation.

In some embodiments, the lithium rich liquor is concentrated to at least about 5000 ppm. In some embodiments, the lithium rich liquor is concentrated to at least about 6000 ppm. In some embodiments, the lithium rich liquor is concentrated to at least about 7000 ppm. In some embodiments, the lithium rich liquor is concentrated to about 4000 to 10000 ppm. In some embodiments, the lithium rich liquor is concentrated to about 5000 to 10000 ppm.

In some embodiments, the regenerated sorbent (hydrogen manganese oxide sorbent) is reused in the process and/or the system.

In some embodiments, the hydrogen manganese oxide sorbent is produced by leaching lithium out of lithium manganese oxide with an acid.

In some embodiments, a base is added to the lithium rich liquor to precipitate the lithium, for example as a lithium salt.

In some embodiments, the base is a carbonate or a hydroxide.

In some embodiments, the base is sodium carbonate.

In some embodiments, the lithium rich liquor is heated to about 40 to 99° C.

In some embodiments, the aqueous solution containing lithium has a lithium concentration of about 0.2 to 8000 ppm. In some embodiments, the aqueous solution containing lithium has a lithium concentration of at least about 1 ppm.

In some embodiments, the aqueous solution containing lithium comprises a silica concentration of about 0 to 1500 ppm. In some embodiments, the aqueous solution containing lithium comprises a silica concentration of greater than 0 to about 1500 ppm. In some embodiments, the aqueous solution containing lithium comprises a silica concentration of about 10 to 1000 ppm. In some embodiments, the aqueous solution containing lithium comprises a silica concentration of about 10 to 500 ppm. In some embodiments, the aqueous solution containing lithium comprises a silica concentration of about 15 to 200 ppm.

In some embodiments, the aqueous solution containing lithium comprises sodium in greater than 0 to about 56,000 ppm concentration. In some embodiments, the aqueous solution containing lithium comprises sodium in about 1 to about 20,000 ppm concentration.

In some embodiments, the aqueous solution containing lithium comprises potassium in greater than 0 to about 25,000 ppm concentration. In some embodiments, the aqueous solution containing lithium comprises potassium in about 1 to about 1000 ppm concentration.

In some embodiments, the aqueous solution containing lithium comprises magnesium in greater than 0 to about 10,000 ppm concentration. In some embodiments, the aqueous solution containing lithium comprises magnesium in about 1 to about 10,000 ppm concentration.

In some embodiments, the aqueous solution containing lithium comprises calcium in greater than 0 to about 10,000 ppm concentration. In some embodiments, the aqueous solution containing lithium comprises calcium in about 1 to about 10,000 ppm concentration. In some embodiments, the aqueous solution containing lithium comprises calcium in about 1 to 8,000 ppm concentration. In some embodiments, the aqueous solution containing lithium comprises calcium in about 200 to 10,000 ppm concentration. In some embodiments, the aqueous solution containing lithium comprises calcium in about 5000 to 10,000 ppm concentration.

In some embodiments, the aqueous solution containing lithium is selected from a geothermal brine, salar brine, sea water, concentrates from processing seawater, a waste stream from a lithium processing facility, a waste or process stream from a battery recycling plant, oil well brines, and other ground water.

Any of the aforementioned features or embodiments or aspects may be combined with one or more of the other features or embodiments or aspects as described herein.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The disclosure consists in the foregoing and also envisages constructions of which the following gives examples only. Features disclosed herein may be combined into new embodiments of compatible components addressing the same or related inventive concepts.

### BRIEF DESCRIPTION OF THE FIGURES

Preferred embodiments of the disclosure will be described by way of example only and with reference to the following drawings.

FIG. 1 shows results of lithium loading testing of different lithium manganese oxide sorbents.

FIG. 2 shows results of lithium loading testing of different lithium manganese oxide sorbents including #9 made from reformed/recycled sorbent from lithium a rich liquor.

### DETAILED DESCRIPTION

In an aspect there is described herein a process for recycling sorbent used in a process for extracting lithium from an aqueous solution containing lithium, the process comprising, (i) bringing an aqueous solution containing lithium into contact with a hydrogen manganese oxide sorbent to absorb the lithium to produce a lithium loaded sorbent and lithium depleted solution, (ii) separating the lithium loaded sorbent and the lithium depleted solution, (iii) bringing the lithium loaded sorbent into contact with an acid to produce a lithium rich liquor and regenerated sorbent, (iv) separating the lithium rich liquor and the regenerated sorbent, (v) treating the separated lithium rich liquor with a carbonate and/or hydroxide to precipitate manganese carbonate and/or manganese hydroxide, (vi) separating precipitated manganese carbonate and/or manganese hydroxide from the lithium rich liquor, and (vii) heating the manganese carbonate and/or manganese hydroxide with a source of lithium to produce a regenerated lithium loaded sorbent which is reused in the process.

In an aspect there is described herein a system for recycling sorbent used in a process for extracting lithium from an aqueous solution containing lithium, the system comprising, a container for bringing an aqueous solution containing lithium into contact with a hydrogen manganese oxide sorbent to absorb the lithium to produce a lithium loaded sorbent and lithium depleted solution, separation means to separate the lithium loaded sorbent and the lithium depleted solution, a source of acid to treat the lithium loaded sorbent to produce a lithium rich liquor and regenerated sorbent, separation means to separate the lithium rich liquor and the regenerated sorbent, carbonate and/or hydroxide dosing means to treat the lithium rich liquor with a carbonate and/or hydroxide to precipitate manganese carbonate and/or manganese hydroxide, precipitate separation means to separate precipitated manganese carbonate and/or manganese hydroxide from the lithium rich liquor, and a heat source and a lithium source to heat the manganese carbonate or manganese hydroxide with the lithium source to produce the lithium loaded sorbent.

Lithium manganese oxide (LMO) sorbents generally have good capacity and speed of lithium absorption, but do not appear to be used commercially due to their relative instability compared to other types of sorbent. For example, a sorbent should remain in solid form during lithium adsorption (upload), and desorption (elute or elution), so that the sorbent can be easily separated and reused in the process. Adsorption (upload) is the replacement of hydrogen ions in the sorbent with lithium, binding the lithium ions. Desorption (elute or elution) is the replacement of lithium ions in the sorbent with hydrogen ions, thereby releasing the lithium ions.

Lithium manganese oxide sorbents tend to dissolve over time so over progressive cycles of upload and elution the sorbent is lost in the lithium rich liquor, meaning that the yield of lithium decreases over time (due to less sorbent being present) or a need to keep replenishing the sorbent, which increases the cost of the process, either of which makes the process less commercially viable.

In the process and/or system described herein the manganese ions that dissolve in the lithium rich liquor are recovered and converted back into more lithium loaded sorbent (lithium manganese oxide).

The lithium loaded sorbent produced in the process may be washed with an acid to produce a hydrogen manganese oxide sorbent ready for reuse (i.e. exchange the lithium in the sorbent with hydrogen so that it is ready for the lithium upload step).

However, this is an additional step that may also result in loss of the lithium (i.e. the lithium from the source of lithium). It is therefore preferred that the lithium loaded sorbent is returned to the cycle with the hydrogen manganese oxide sorbent. Although the lithium loaded sorbent will not be active (i.e. upload lithium) in the first cycle after being introduced, the lithium will be eluted in the next elution step (i.e. bringing the lithium loaded sorbent into contact with an acid to produce a lithium rich liquor and regenerated sorbent), which will mean recovery of the lithium used in the step of heating the manganese carbonate and/or manganese hydroxide with the source of lithium. In this way the lithium loaded sorbent formed by heating the manganese carbonate and/or manganese hydroxide with a source of lithium may be added directly back into the process without being initially activated with acid, thereby conserving lithium and reducing process steps.

Although the process and/or system recovers much of the manganese which dissolves in the lithium rich liquor, optionally further manganese may be added periodically. For example, when the precipitated manganese carbonate and/or manganese hydroxide is heated with a source of lithium, additional manganese, for example Mn₂O₃ or Mn₃O₄ may be added. For example, precipitated MnCO₃, Li₂CO₃ and a small makeup mass of Mn₃O₄ may be mixed (for example in a ribbon blender) and then fed into a furnace (for example a continuous furnace) to manufacture fresh make up lithium manganese oxide (LMO). After the heat treatment, the sorbent may be sent back to the upload area to replace fines losses.

The lithium rich liquor is preferably treated with a carbonate so that precipitated manganese carbonate is separated from the lithium rich liquor and manganese carbonate is heated with the source of lithium. Carbonate is preferred as manganese carbonate is a friable solid that is relatively easy to handle, for example it is relatively easy to break down into powder.

### Heating to Produce the Lithium Loaded Sorbent

The manganese carbonate and/or manganese hydroxide is heated with a source of lithium/lithium source to produce the lithium loaded sorbent (lithium manganese oxide sorbent). The source of lithium/lithium source is preferably one or more of lithium hydroxide, lithium carbonate or lithium oxide.

Preferably the source of lithium is heated with the manganese carbonate and/or manganese hydroxide at a mole ratio of about 1:1 to 1:3 lithium to manganese, preferably a mole ratio of about 0.75 lithium to manganese (for example, a mole ratio of 0.75 Li to 1 Mn).

The manganese carbonate and/or manganese hydroxide is preferably calcined with the source of lithium, for example they are in solid form.

The manganese carbonate and/or manganese hydroxide may be heated, for example in a furnace, at about 300 to 1000° C. with the source of lithium, for about 1 to 72 hours. For example, the manganese carbonate and/or manganese hydroxide may be heated at about 300 to 900° C. with the source of lithium, for about 1 to 24 hours, at about 400 to 800° C. with the source of lithium, for about 4 to 12 hours, at about 450 to 700° C. with the source of lithium, for about 4 to 12 hours, or at about 450 to 700° C. for about 4 to 8 hours with the source of lithium, preferably for about 5 hours.

The manganese carbonate and/or manganese hydroxide is preferably heated, for example in a furnace, at about 400 to 800° C. with the source of lithium, preferably for about 4 to 12 hours, or at about 450 to 700° C. with the source of lithium, preferably for about 4 to 12 hours, or at about 450 to 700° C. for about 4 to 8 hours with the source of lithium, preferably for about 5 hours.

The manganese carbonate is preferably heated at higher temperature than the manganese hydroxide, for example, at about 550 to 800° C., preferably for about 4 to 12 hours with the source of lithium, or at about 600 to 700° C. with the source of lithium, preferably for about 4 to 12 hours.

The manganese carbonate and/or manganese hydroxide and the source of lithium may be milled together prior to heating and/or after heating. The lithium loaded sorbent (lithium manganese oxide sorbent) that is formed may be washed (for example with water) and may be dried.

Precipitating the Manganese Carbonate and/or Manganese Hydroxide

The carbonate used to precipitate manganese carbonate is preferably any one or more of sodium carbonate, ammonium carbonate, and potassium carbonate, preferably sodium carbonate.

The hydroxide used to precipitate manganese hydroxide is preferably any one or more of sodium hydroxide, potassium hydroxide, and ammonium hydroxide. Ammonia will form ammonium hydroxide when in contact with water.

In some embodiments, the lithium rich liquor is treated with a stoichiometric excess of the carbonate and/or hydroxide to the dissolved manganese. In some embodiments, the lithium rich liquor is treated with a small stoichiometric excess of the carbonate and/or hydroxide to the dissolved manganese. In some embodiments, the lithium rich liquor is treated with a 5% stoichiometric excess of the carbonate and/or hydroxide to the dissolved manganese. In some embodiments, the lithium rich liquor is treated with a 10% stoichiometric excess of the carbonate and/or hydroxide to the dissolved manganese. In some embodiments, the lithium rich liquor is treated with a 20% stoichiometric excess of the carbonate and/or hydroxide to the dissolved manganese. In some embodiments, the lithium rich liquor is treated with a stoichiometric amount of the carbonate and/or hydroxide to the dissolved manganese. The carbonate and/or hydroxide is preferably added until a basic or neutral pH is achieved, preferably until pH about 6 to 8 is achieved. Manganese will preferentially precipitate out before lithium, so the lithium will remain in solution.

A base may be added to the separated lithium rich liquor in addition to the carbonate and/or hydroxide, preferably before the carbonate and/or hydroxide to decrease excess acid. The additional base may be added to the separated lithium rich liquor to adjust the pH to about 3-4.

Once the manganese carbonate and/or manganese hydroxide have precipitated, the manganese carbonate or manganese hydroxide is separated from the lithium rich liquor, for example by filtration, may be washed (for example with water) and may be dried.

### Aqueous Solution Containing Lithium

The aqueous solution containing lithium may be obtained from a range of sources, for example geothermal brine, salar brine, sea water, concentrates from processing seawater, a waste stream from a lithium processing facility, a waste or process stream from a battery recycling plant, oil well brines, and other ground water. For example, geothermal brine may be used which has been processed by a silica extraction plant to remove or reduce silica. Some sources may be naturally warm (for example 40° C.) without the need to heat the aqueous solution containing lithium, for example a geothermal source. Preferably the aqueous solution containing lithium has a lithium concentration of over zero (for example 0.1 ppm) to about 8000 ppm.

The aqueous solution containing lithium will generally comprise other minerals, ions etc., which are preferably separated or reduced from the aqueous solution containing lithium by the process and/or system. For example, common contaminants are silica, sodium, potassium, magnesium and/or calcium.

The process and/or system for recycling sorbent used in a process for extracting lithium from an aqueous solution containing lithium described herein may be used in a process and/or system for extracting lithium from an aqueous solution containing lithium where a lithium manganese oxide is used.

Various embodiments are described with reference to the Figures.

### Examples

### 1. Sorbent Synthesis Experiments

### 1.1 Experimental:

Lithium manganese oxide (LMO) sorbents were synthesized by heat-treating Li₂CO₃ and Mn₃O₄ at different mole ratios, temperatures, with different dopants and times. Table 1 details the synthesis conditions.

Various LMOs were treated for 48 hours with 1 M H₂SO₄ to activate the LMO. It is believed that the activated form of the LMO is a hydrogen manganese oxide sorbent.

The LMOs were then washed with water. 2 g of the wet sorbent was added to 5 L of 10 ppm lithium rich geothermal brine. Capacity was determined after 60 minutes contact time.

For comparison, LMO-C(a commercially obtained LMO cathode material from China) was treated with the same activation treatment.

TABLE 1

| | Mole ratio | Temperature | Time in furnace | |
|---|---|---|---|---|
| Name | (Li:Mn) | (° C.) | (hours) | Dopant |
| D2 | 0.60 | 650 | 5 | — |
| D3 | 0.60 | 750 | 5 | — |
| D4 | 0.5 | 650 | 5 | — |
| D5 | 0.5 | 750 | 5 | — |
| D6 | 0.60 | 650 | 5 | Mg (5-10%) |
| D7 | 0.60 | 750 | 5 | Mg (5-10%) |
| MnCO₃ | 0.60 | 650 | 5 | — |
| MnCO₃ | 0.60 | 500 | 2 | — |

### 1.2 Results

The synthesized LMOs were activated and tested for capacity. As can be seen in Table 2, all the LMOs were active. The LMO-C had the greatest capacity. Between the different mole ratios (D2, D3 and D4, D5) there was a significant difference in capacity. The higher calcination temperature reduced the capacity slightly (compare D2 and D3, D6 and D7), except in D4 and D5. The LMO synthesized from MnCO₃ (650° C., 5 hours) was active and had a capacity of 13.5 mg/g. The Mg-doped sorbents had significantly reduced capacity. The MnCO₃ (500° C., 5 hours) was not active. It is believed the temperature and/or time was too low to decompose the carbonates.

TABLE 2

| | Li conc | Mn conc | | |
|---|---|---|---|---|
| | (mg/l) | (mg/l) | Li/Mn | Capacity |
| Sample | Activation | Activation | Activation | (mg/g) |
| LMO—C loaded | 1145 | 2643 | 0.43322 | 15 |
| D2 | 3431 | 5219 | 0.657406 | 13.5 |
| D3 | 3441 | 5203 | 0.661349 | 10.75 |
| D4 | 4148 | 2493 | 1.663859 | 11.725 |
| D5 | 3716 | 3322 | 1.118603 | 13.375 |
| LMO—C fresh | 3423 | 4777 | 0.716559 | 14.45 |
| D6 (mg doped) | 2796 | 2502 | 1.117506 | 4.6 |
| D7 (mg doped) | 2403 | 2823 | 0.851222 | 3.9 |
| MnCO₃ 650 C. | 3650 | 4614 | 0.791071 | 13.5 |
| MnCO₃ 500 C. 2 hr | 2898 | 4924 | 0.588546 | NA |

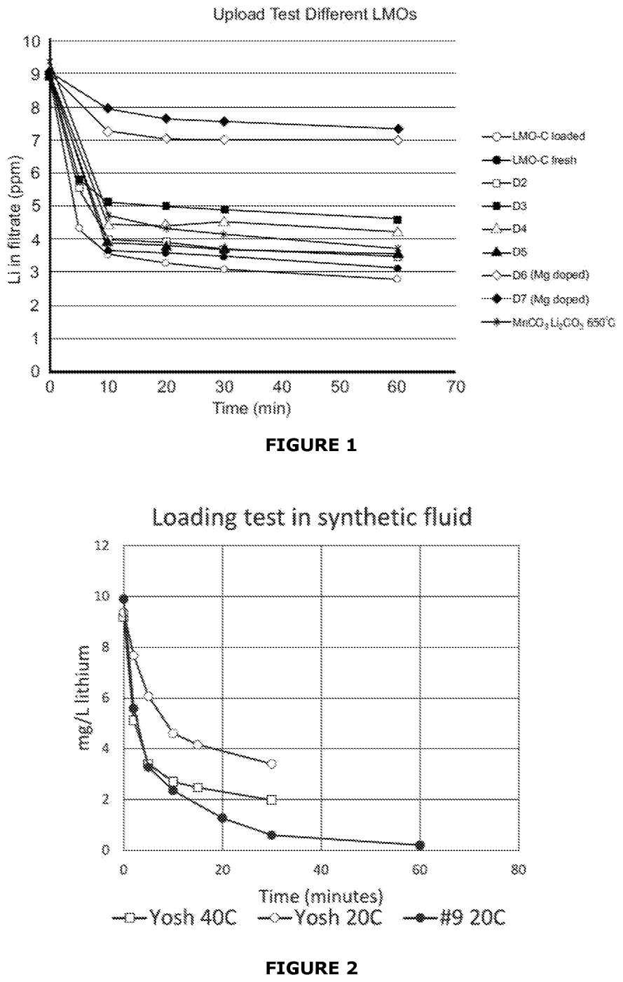

The rate of loading of lithium was examined. The results are shown in FIG. 1. The rate of loading was similar in all the non-doped sorbents, however, the LMO-C was the fastest.

### 2. Multi-Cycle Testing of Lithium Manganese Oxide Sorbents

Two sorbents were tested in multi-cycles. The first sorbent was LMO-C (comparative example). It was a lambda-phase manganese containing the lithium exchange sites. Its intended use is in lithium ion batteries.

The second material is LMO made using manganese recovered from a lithium pilot plant (i.e. recovered from lithium rich liquor, referred to here as “sorbent #9”). The LMO was made using manganese carbonate (the solid form of manganese recovered from the plant) and lithium carbonate (which can be also obtained from the process). The two solids (MnCO₃ and Li₂CO₃) were blended together in a ball mill, and then heated for 5 hours at 600° C. The resulting powdered sorbent was then tested and had performance similar to the best material tested to date. This demonstrated recycling of the manganese to be possible and fairly inexpensive.

Testing of the LMO-C material completed 24 cycles. The remaining sorbent was recovered at the end of the test and lithium uptake capacity and kinetics determined. The recovered material behaved similarly to the original material.

The LMO-C material did not have the capacity as high as our in-house sorbents and also loaded more slowly and did not remove lithium to low levels as did our materials.

Testing of the second material (sorbent #9) was completed through 41 cycles. Interim results at 20 cycles showed the sorbent had the expected performance.

### 3. MnCO₃ Precipitation

### 3.1 Experimental

200 L of a mixture of acidic lithium-rich liquor from multiple regeneration cycles and activations was filtered through a filter press. While mixing, NaOH (50%) was added until the mixture was pH 3.5. Then Na₂CO₃ dissolved in water was added at a theoretical molar equivalent to the remaining Mn²⁺ in the lithium-rich liquor. As not all the Mn²⁺ precipitated more Na₂CO₃ was added. Then the lithium-rich liquor was filtered and the MnCO₃ cake air-dried for 15 minutes.

### 3.2 Results

The addition of NaOH to the liquor increased the pH to 3.5. NaOH was used as limited Na₂CO₃ was available. However, the concentrated sodium hydroxide caused some localized Mn(OH)₂ precipitation. This can be seen as a decrease from 859 to 724 ppm in Table 3.

The precipitation of the Mn(OH)₂ also absorbed some lithium from the solution as seen by the decrease from 391 to 351 ppm.

The addition of the Na₂CO₃ precipitated approximately half the Mn²⁺ in solution despite being theoretically a molar equivalent. It was believed the Na₂CO₃ was not anhydrous (as had been used for calculations). After another addition of Na₂CO₃, the Mn²⁺ was reduced to 27 ppm (97% yield). It was believed ageing or a slight excess of Na₂CO₃ would have reduced the Mn²⁺ further.

Interestingly, the carbonate precipitation also removed Al, As, Ca, Co, Cr, Pb and Zn, see Table 3. The MnCO₃ cake filtered easily and was dry and friable after the air-blow.

The precipitated MnCO₃ was tested for purity with ICP-OES, see Table 4. It was found the MnCO₃ had a purity of around 98%. The main contaminants were Al, Ca (above detector saturation), Na and Zn. Given the low levels of contaminants, there doesn't appear to be any reason this can't be used for LMO/hydrogen manganese oxide sorbent synthesis.

TABLE 3
ICP results of MnCO₃ precipitation.

| | | | | | | | | | | | | | | | | | | | | |
|---|---|---|---|---|---|---|---|---|---|---|---|---|---|---|---|---|---|---|---|---|
| Al | As | B | Ba | Ca | Cd | Co | Cr | Cu | K | Li | Mg | Mn | Mo | Na | Ni | Pb | Se | Si | Sr | Zn |

Start

| | | | | | | | | | | | | | | | | | | | | |
|---|---|---|---|---|---|---|---|---|---|---|---|---|---|---|---|---|---|---|---|---|
| 9.02 | 0.41 | 5.04 | 0.05 | 18.06 | 0 | 0.05 | 0.22 | 0.21 | 27.51 | 391 | 1.52 | 859 | 0 | 389 | 0.06 | 0.11 | 0.77 | 27.37 | 0.8 | 1.39 |

After NaOH

| | | | | | | | | | | | | | | | | | | | | |
|---|---|---|---|---|---|---|---|---|---|---|---|---|---|---|---|---|---|---|---|---|
| 9.18 | 0.23 | 4.61 | 0.05 | 17.64 | 0 | 0.04 | 0.15 | 0.22 | 34.62 | 359 | 1.42 | 724 | 0 | 2089 | 0.05 | 0.08 | 0.64 | 27.26 | 0.82 | 1.57 |

After Na₂CO₃ 500 g

| | | | | | | | | | | | | | | | | | | | | |
|---|---|---|---|---|---|---|---|---|---|---|---|---|---|---|---|---|---|---|---|---|
| 0.13 | −0.01 | 3.93 | 0.01 | 13.23 | 0 | 0.02 | 0.05 | 0.18 | 35.01 | 328 | 1.32 | 196 | 0 | 2872 | 0.03 | 0.02 | 0.35 | 15 | 0.59 | 0.01 |

After another 90 g Na₂CO₃

| | | | | | | | | | | | | | | | | | | | | |
|---|---|---|---|---|---|---|---|---|---|---|---|---|---|---|---|---|---|---|---|---|
| 0.13 | 0 | 3.71 | 0 | 10.51 | 0 | 0.01 | 0.02 | 0.16 | 30.66 | 303 | 1.39 | 26 | 0 | 2771 | 0.03 | 0 | 0.23 | 12.91 | 0.49 | 0 |

TABLE 4
ICP results of the overall purity of the MnC0₃
Purity Product (%)

| Al | As | B | Ba | Ca | Cd | Co | Cr | Cu | K | Li | Mg | Mn | Mo | Na | Ni | Pb | Se | Si | Sr | Zn |
|---|---|---|---|---|---|---|---|---|---|---|---|---|---|---|---|---|---|---|---|---|
| 0.56 | 0.02 | 0.01 | 0.00 | XXX | 0.00 | 0.00 | 0.01 | 0.00 | 0.01 | 0.13 | 0.01 | 47.00 | 0.00 | 0.31 | 0.00 | 0.01 | 0.03 | 0.77 | 0.02 | 0.10 |

| | |
|---|---|
| Overall Purity | 98% |

### 4. Loading Performance Tests

Tests were carried out on a range of sorbents to confirm the reformed/recycled sorbent would have comparable lithium loading capabilities.

### 4.1 LMO Synthesis

The LMO was synthesized from the MnCO₃ precipitate in in Example 3, using a Li/Mn ratio of 0.75, with Li₂CO₃, heating for 5 hours at 600° C.

4.2 Test Conditions

The LMO (made from MnCO₃ precipitate and two using the Yoshizuka synthesis method with Li/Mn=0.75 for comparison) were pre-soaked in 0.5M H₂SO₄ for 12 hours and then rinsed to a conductively measurement of 5 μS (the same as deionized water).

The experiments were carried out in a stirred beaker with 1L volume synthetic brine (10 ppm Li solution+Na+Si) with 1.1 grams sorbent at 20° C.

### 4.3 Results

The results are shown in FIG. 2. The LMO was synthesized from the MnCO₃ precipitate (labelled #9 on graph) performed very well. The higher surface area may explain better performance of #9 compared to the Yoshizuka synthesis method sorbents.

Where, in the foregoing description reference has been made to integers or components having known equivalents thereof, those integers are herein incorporated as if individually set forth.

Although the present disclosure has been described in terms of certain embodiments, other embodiments apparent to those of ordinary skill in the art also are within the scope of this disclosure. Thus, various changes and modifications may be made without departing from the spirit and scope of the disclosure. For instance, various components may be repositioned as desired. Moreover, not all of the features, aspects and advantages are necessarily required to practice the present disclosure. Accordingly, the scope of the present disclosure is intended to be defined only by the claims that follow.

1. A process for recycling sorbent used in a process for extracting lithium from an aqueous solution containing lithium, the process comprising:
(i) bringing an aqueous solution containing lithium into contact with a hydrogen manganese oxide sorbent to absorb the lithium to produce a lithium loaded sorbent and lithium depleted solution;
(ii) separating the lithium loaded sorbent and the lithium depleted solution;
(iii) bringing the lithium loaded sorbent into contact with an acid to produce a lithium rich liquor and regenerated sorbent;
(iv) separating the lithium rich liquor and the regenerated sorbent;
(v) treating the separated lithium rich liquor with a carbonate and/or hydroxide to precipitate manganese carbonate and/or manganese hydroxide;
(vi) separating precipitated manganese carbonate and/or manganese hydroxide from the lithium rich liquor; and
(vii) heating the manganese carbonate and/or manganese hydroxide with a source of lithium to produce a regenerated lithium loaded sorbent which is reused in the process.

2. A system for recycling sorbent used in a process for extracting lithium from an aqueous solution containing lithium, the system comprising:
a container for bringing an aqueous solution containing lithium into contact with a hydrogen manganese oxide sorbent to absorb the lithium to produce a lithium loaded sorbent and lithium depleted solution;
separation means to separate the lithium loaded sorbent and the lithium depleted solution;
a source of acid to treat the lithium loaded sorbent to produce a lithium rich liquor and regenerated sorbent;
separation means to separate the lithium rich liquor and the regenerated sorbent;
carbonate and/or hydroxide dosing means to treat the lithium rich liquor with a carbonate and/or hydroxide to precipitate manganese carbonate and/or manganese hydroxide;
precipitate separation means to separate precipitated manganese carbonate and/or manganese hydroxide from the lithium rich liquor; and
a heat source and a lithium source to heat the manganese carbonate or manganese hydroxide with the lithium source to produce the lithium loaded sorbent.

3. The process of claim 1, wherein the lithium rich liquor is treated with a carbonate, and precipitated manganese carbonate is separated from the lithium rich liquor and manganese carbonate is heated with the source of lithium.

4. The process of claim 1, wherein
the source of lithium comprises one or more of lithium hydroxide, lithium carbonate or lithium oxide; and/or
wherein the source of lithium is heated with the manganese carbonate and/or manganese hydroxide at a mole ratio of about 1:1 to 1:3 lithium to manganese; or a mole ratio of about 0.75 lithium to manganese.

5-8. (canceled)

9. The process of claim 1, wherein the manganese carbonate and/or manganese hydroxide is heated at about 300 to 1000° C. with the source of lithium; preferably for about 1 to 72 hours; or
wherein the manganese carbonate and/or manganese hydroxide is heated at about 400 to 800° C. with the source of lithium; preferably for about 4 to 12 hours, or for about 4 to 8 hours, or for about 5 hours; or
wherein the manganese carbonate is heated at about 550 to 800° C. with the source of lithium; preferably for about 4 to 12 hours; or
wherein the manganese carbonate is heated at about 600 to 700° C. with the source of lithium; preferably for about 4 to 12 hours; or
wherein the manganese carbonate is heated at about 600 to 700° C. for about 4 to 8 hours with the source of lithium; or for about 5 hours.

10-14. (canceled)

15. The process of claim 1, wherein the carbonate is any one or more of sodium carbonate, ammonium carbonate, and potassium carbonate or wherein the carbonate is sodium carbonate.

16. The process of claim 1, wherein the hydroxide is any one or more of sodium hydroxide, potassium hydroxide, and ammonium hydroxide.

17. The process of claim 1, wherein the separated lithium rich liquor is treated with the carbonate and/or hydroxide until a basic or neutral pH is achieved or until a pH of about 6 to 8 is achieved:
wherein optionally, a base is added to the separated lithium rich liquor in addition to the carbonate and/or hydroxide; or
wherein optionally, the base is added to the separated lithium rich liquor to adjust the pH to about 3 to 4.

18. (canceled)

19. The process of claim 1, wherein the manganese carbonate or manganese hydroxide is separated from the lithium rich liquor by filtration.

20. (canceled)

21. The process of claim 1, wherein the manganese carbonate and/or manganese hydroxide and the source of lithium are milled together;
wherein optionally, the lithium loaded sorbent is ball milled, ring milled, and/or bead milled after heating; or
wherein optionally, the lithium loaded sorbet is milled to a powder having a particle size of about less than 100 microns after heating.

22-23. (canceled)

24. The process of claim 1, wherein the amount of hydrogen manganese oxide sorbent contacted with the aqueous solution containing lithium is in excess capacity to the amount of lithium in the aqueous solution, or wherein the amount of the hydrogen manganese oxide sorbent is in about 1 to 3 capacity to the amount of lithium in the aqueous solution:
wherein the hydrogen manganese oxide sorbent in step (i) is in excess capacity to the amount of lithium in the in the aqueous solution; or wherein the hydrogen manganese oxide sorbent in step (i) is in about over 1 to 3 capacity to the amount of lithium in the aqueous solution; and/or
wherein the aqueous solution containing lithium is agitated and/or stirred when contacted with the hydrogen manganese oxide sorbent; and/or
wherein the aqueous solution is in contact with the hydrogen manganese oxide sorbent for about 20 seconds to 12 hours, or about 30 seconds to 12 hours; or about 1 minute to 12 hours; or about 1 minute to 10 hours; or about 1 minute to 8 hours; or about 1 minute to 6 hours; or about 1 minute to 5 hours; or about 1 minute to 4 hours; or about 2 minutes to 4 hours; or about 5 minutes to 3 hours; and/or
wherein the hydrogen manganese oxide sorbent is brought into contact with the aqeuous solution containing lithium at about 1 to 500 g/L; or about 1 to 200 g/L; or about 1 to 100 g/L; or about 5 to 50 g/L.

25-28. (canceled)

29. The process of claim 1, wherein water is added to the separated lithium loaded sorbent; or
wherein water is added to the separated lithium loaded sorbent at about 1 to 1000 g/L; or about 200 to 900 g/L; or about 400 to 900 g/L; or about 600 to 900 g/L; or about 700 g/L.

30. The process of claim 1, wherein the acid in step (iii) or the source of acid is selected from one or more mineral acids and/or organic acids; and/or
wherein the acid in step (iii) or the source of acid substantially does not dissolve the sorbent; and/or
wherein the acid in step (iii) or the source of acid is selected from one or more of HCl, H₂SO₄, HBr, HI and phosphoric acid.

31-32. (canceled)

33. The process of claim 1, wherein the acid in step (iii) or the source of acid is added until pH of about 1 to 2 is achieved; and/or
wherein the acid in step (iii) or the source of acid is added at about 2:1 to 1:1 ratio of acid to the lithium held by the sorbent; and/or
wherein the acid in step (iii) or the source of acid is added at about 1:1 stoichiometric ratio of acid to the lithium held by the sorbent.

34-40. (canceled)

41. The process of claim 1, further comprising concentrating the lithium rich liquor.

42. The process system of claim 41; wherein the concentrating of the lithium rich liquor is prior to separating the lithium rich liquor and the regenerated sorbent;
and/or the concentrating of the lithium rich liquor is after separating the lithium rich liquor and the regenerated sorbent; and/or
the concentrating of the lithium rich liquor is after separating precipitated manganese carbonate and/or manganese hydroxide from the lithium rich liquor; and/or
the concentrating of the lithium rich liquor is prior to separating precipitated manganese carbonate and/or manganese hydroxide from the lithium rich liquor;
wherein optionally, the lithium rich liquor is concentrated to at least about 5000 ppm; or at least 6000 ppm; or at least 7000 ppm; or about 4000 to 10000 ppm; or about 5000 to 10000 ppm.

43-45. (canceled)

46. The process of claim 1, wherein the hydrogen manganese oxide sorbent is produced by leaching lithium out of lithium manganese oxide with an acid.

47. The process of claim 1, wherein a base is added to the lithium rich liquor to precipitate the lithium, for example as a lithium salts;
wherein optionally, the base is a carbonate or hydroxide.

48. (canceled)

49. The process of claim 1, wherein the lithium rich liquor is heated to about 40 to 99° C.

50. The process of claim 1,
wherein the aqueous solution containing lithium has a lithium concentration of about 0.2 to 8000 ppm; or at least about 1 ppm; and/or
wherein the aqueous solution containing lithium comprises a silica concentration of about 0 to 1500 ppm; or greater than 0 to about 1500 ppm; or about 10 to 1000 ppm; or about 10 to 500 ppm; or about 15 to 200 ppm and/or
wherein the aqueous solution containing lithium comprises sodium in greater than 0 to about 56,000 ppm concentration; or about 1 to 20,000 ppm; and/or
wherein the aqueous solution containing lithium comprises potassium in greater than 0 to about 25,000 ppm concentration; or about 1 to 1000 ppm; and/or
wherein the aqueous solution containing lithium comprises magnesium in greater than 0 to about 10,000 ppm concentration; or about 1 to 10,000 ppm; and/or
wherein the aqueous solution containing lithium comprises calcium in greater than 0 to about 10,000 ppm concentration; or about 1 to 10,000 ppm; or about 1 to 9,000 ppm; or about 200 to 10,000 ppm; or about 5000 to 10,000 ppm; and/or
wherein the aqueous solution containing lithium is selected from a geothermal brine, salar brine, sea water, concentrates from processing seawater, a waste stream from a lithium processing facility, a waste or process stream from a battery recycling plant, oil well brines, and other ground water.

51-56. (canceled)
